(19) United States
(12) Patent Application Publication
(10) Pub. No.: US 2025/0382976 A1
(43) Pub. Date: Dec. 18, 2025

(54) Centrifugal pump

(71) Applicant: WILO SE, Dortmund (DE)

(72) Inventors: Thomas Keil, Dortmund (DE); Andreas Zeiß, Dortmund (DE); Johannes Reuschel, Dortmund (DE); Jonas Sonntag, Dortmund (DE); Jörg Haase, Dortmund (DE); Volker Netsch, Dortmund (DE); Olivier Armbruster, Dortmund (DE); Alfred Otto, Dortmund (DE)

(21) Appl. No.: 19/240,622

(22) Filed: Jun. 17, 2025

(30) Foreign Application Priority Data
Jun. 18, 2024 (BE) 2024/5362

(51) Int. Cl. F04D 29/70; F04D 1/00; F04D 29/42

(52) U.S. Cl. CPC F04D 29/708; F04D 1/00; F04D 29/4293

(57) ABSTRACT

A centrifugal pump includes an impeller defining an axis for conveying a fluid, a centrifugal chamber, into which the impeller is axially inserted, and a suction strainer, into which the centrifugal chamber is axially inserted, wherein the centrifugal chamber has at least one pressure outlet leading from the impeller to the suction strainer for receiving a portion of the fluid conveyed by the impeller, the suction strainer has at least one base-side and at least one lateral suction opening for sucking in the fluid and at least one bypass line, connectable to the at least one pressure outlet, for purging the centrifugal pump and/or the suction strainer, and the centrifugal chamber and the suction strainer are rotatable and/or axially displaceable relative to one another in at least a first, a second and a third position, in such a way that at least in the first position the at least one lateral suction opening is open, in the second position the at least one lateral suction opening is deactivated and in the third position the at least one pressure outlet is connected to the at least one bypass line.

### CROSS-REFERENCE TO RELATED APPLICATIONS

The present application is based upon and claims the right of priority to BE Patent Application No. 2024/5362, filed Jun. 18, 2024, the disclosure of which is hereby incorporated by reference herein in its entirety for all purposes.

### TECHNICAL FIELD

The invention relates to a centrifugal pump with an impeller defining an axis for conveying a fluid, a centrifugal chamber in which the impeller is axially inserted, and a suction strainer in which the centrifugal chamber is axially inserted, wherein the suction strainer has at least one lateral suction opening for drawing in the fluid.

### BACKGROUND TO THE INVENTION

Centrifugal pumps are known from the prior art and are used to convey a liquid as fluid by means of a rotary movement of an impeller. The liquid to be conveyed enters a pump chamber of the centrifugal pump through a suction opening, is captured by the rotating impeller and subsequently conveyed into a pressure outlet. Any solids contained in the liquid may settle in the region of the impeller and on the inside of a pump housing and thus negatively affect the hydraulic and/or mechanical efficiency of the centrifugal pump or even cause the centrifugal pump to become blocked and fail.

Although various designs of centrifugal pumps are known from the prior art, current practice shows that the known designs are not ideal for being able to use a centrifugal pump optimally in different application situations.

### DESCRIPTION OF THE INVENTION

On the basis of this situation, an objective of the present invention is to provide a centrifugal pump that may be easily adapted to different application situations.

The objective of the invention is achieved by the features of the independent claim. Advantageous embodiments are specified in the dependent claims.

Accordingly, the objective is achieved by a centrifugal pump with an impeller defining an axis for conveying a fluid, a centrifugal chamber into which the impeller is axially arranged inserted, and a suction strainer, in which the centrifugal chamber is axially inserted, wherein
the centrifugal chamber has at least one pressure outlet leading from the impeller to the suction strainer for receiving part of the fluid conveyed by the impeller,
the suction strainer has at least one base-side and at least one lateral suction opening for sucking in the fluid and at least one bypass line connectable to the at least one pressure outlet for purging the centrifugal pump and/or the suction strainer, and
the centrifugal chamber and the suction strainer are rotatable and/or axially displaceable relative to one another into at least a first, a second and a third position in such a way that at least in the first position the at least one lateral suction opening is open, in the second position the at least one lateral suction opening is deactivated and in the at least third position in particular the at least one pressure outlet is connected to the at least one bypass line.

A key point of the invention is that the centrifugal pump proposed has an adjustment mechanism in the form of the centrifugal chamber and suction strainer, which are rotatable and/or axially displaceable relative to one another, whereby different operating modes of the centrifugal pump, which is configured in particular as an untreated waste water pump, may be set. While normal operation of the centrifugal pump preferably takes place in the first position, in which the fluid is drawn in in particular through the at least one lateral suction opening and preferably also through the at least one base-side suction opening, a so-called flat suction may be realised in the second position, in which the at least one lateral suction opening is deactivated and the fluid is drawn in in particular only through the at least one base-side suction opening. Finally, in the at least third position, a flushing function may be realised inside and/or outside the suction strainer, as already described above in the latter case, in which fluid first flows in and then partially flows out through the at least one bypass line.

In this way, the proposed centrifugal pump is characterised by a variety of different operating modes, which may be easily set by rotating and/or moving the centrifugal chamber and the suction strainer relative to each other, in particular as required and/or manually. These different operating modes may be varied without time-consuming manual conversion of the centrifugal pump and without the use of tools. These different operating modes may be varied, for example, without time-consuming manual conversion of the centrifugal pump and/or without the use of tools. In addition, different operating modes are possible for purging the centrifugal pump, either internally or externally, allowing deposits to be removed quickly, especially from the outside of the centrifugal pump.

A centrifugal pump is generally referred to as a flow machine that utilises a rotary motion and dynamic forces to convey predominantly liquids as fluid. In addition to a tangential acceleration of the liquid, a centrifugal force in radial flow is used for pumping in the centrifugal pump, so that such pumps are also referred to as centrifugal pumps. The centrifugal pump may preferably be used for a hydraulic system in a building or other applications, in particular as a waste water pump.

During the regular operation of the centrifugal pump, a housing of a motor of the centrifugal pump may be arranged above a pump housing, in which the impeller driven by the motor via a shaft is provided for conveying the liquid and the centrifugal chamber. The housing of the motor may be connected to the pump housing in a fixed position and/or may be configured in one piece. The centrifugal pump and the motor may also each have their own shaft, wherein the shafts may be connected to one another via a coupling. Preferably, the shaft protrudes from the housing of the motor into the pump housing on a drive side and/or is fixed to the shaft on the drive side of the impeller. Accordingly, the side or base-side suction opening for the fluid to be conveyed is preferably arranged at the bottom of the pump housing. In particular, the suction strainer is configured to be removable from the centrifugal chamber. The at least one bypass line preferably opens out close to the base so as to lose minimal flow energy.

The fluid or liquid preferably comprises water or another liquid medium such as waste water. The fluid or liquid may contain solids such as impurities or waste of any kind, in particular faeces, sediments, dirt, sand, or even small pieces of wood, undergrowth, textiles or rags or the like. Preferably, the housing of the motor and/or the pump housing is made of metal, in particular cast iron or stainless steel, ceramic and/or plastic.

The impeller is preferably inserted at least with its blades, in particular completely into the centrifugal chamber. Likewise, the centrifugal chamber may preferably be fully inserted into the suction strainer or the suction strainer may be placed axially on the centrifugal chamber in such a way that the suction strainer axially and/or radially surrounds the centrifugal chamber, in particular at least in one of the positions, preferably in all positions. Accordingly, an outer shape of the impeller is preferably configured to correspond to an inner shape of the centrifugal chamber, while an outer shape of the centrifugal chamber is preferably configured to correspond to an inner shape of the suction strainer. The pressure outlet preferably extends radially through an axially extending centrifugal chamber side wall of the centrifugal chamber. Further preferably, the pressure outlet is arranged axially at the level of a radially extending centrifugal chamber base of the centrifugal chamber or directly axially above it. Preferably, a plurality of pressure outlets are provided, which are arranged in particular at regular intervals, preferably at a distance of 90° from each other.

The suction strainer preferably has a radially extending suction strainer base and an adjoining, axially extending suction strainer side wall that radially surrounds the suction strainer base. Accordingly, the at least one base-side suction opening is preferably provided in the suction strainer base and/or the at least one lateral suction opening is preferably provided in the suction strainer side wall. Preferably, the at least one lateral suction opening is provided on a radial end face of the suction strainer and/or the at least one base-side suction opening is provided on an axial end face of the suction strainer. Further preferably, a plurality of base-side and/or lateral suction openings are provided, which are arranged at regular intervals and/or adjacent to one another. Very particularly preferably, four groups of three, four, five or six lateral suction openings are provided, wherein, when the centrifugal chamber is inserted into the suction strainer, a respective pressure outlet is preferably provided substantially between two groups. The at least one lateral suction opening preferably extends orthogonally to the axis with respect to its normal, while the at least one base-side suction opening preferably extends parallel to the axis with respect to its normal. The suction strainer side wall preferably extends linearly, in particular substantially linearly and/or slightly curved.

The at least one lateral suction opening is preferably provided axially at the level of the suction strainer base or directly above it. Insofar as relative terms such as above or below are used in the context of the disclosure, these terms refer to the axis in the direction of the impeller or shaft. It is also assumed that the suction strainer may be placed on a floor with its underside facing away from the centrifugal chamber, so that relative terms such as below axially refer to the floor. The term deactivated means in particular closed, partially closed or screened.

The bypass line is preferably arranged partially, in particular completely, inside the suction strainer, in particular in the suction strainer side wall. Preferably, the pressure outlet may be connected and/or sealed to the bypass line in a fluid-tight manner by twisting and/or axially displacing the suction strainer and the centrifugal chamber relative to each other. Sealing may be achieved in particular by the pressure outlet making contact with the suction strainer side wall. Preferably, the suction strainer and the centrifugal chamber are sealed against each other in a fluid-tight manner, in particular at their edges facing away from the floor, for example by a seal or a sealing lip provided in particular radially between the suction strainer and the centrifugal chamber. Furthermore, the centrifugal chamber and/or the suction strainer are preferably provided with a device for latching in the respective position, in particular in each position.

According to a preferred development, the at least one pressure outlet and/or the at least one bypass line is deactivated in the first position and/or in the second position, only the base-side suction opening is open in the second position, the at least one lateral suction opening is open in the third position and/or only the at least one pressure outlet is connected to the at least one bypass line in the third position. If the at least one pressure outlet and/or the at least one bypass line is deactivated in the first position and/or in the second position, no fluid may be flushed back through the pressure outlet in a suction region of the centrifugal pump, so that optimum pump performance is achieved. By opening the base-side suction opening only in the second position, optimum flat suction is made possible. Finally, when connecting the at least one pressure outlet to the at least one bypass line in the third position, fluid that has been discharged outside the suction strainer for purging may be drawn in again through the lateral suction opening by opening the lateral suction opening or not closing the lateral suction opening.

According to a further preferred embodiment, the at least one bypass line opens outside the suction strainer for purging the centrifugal pump and/or in the suction strainer for purging the suction strainer. Preferably, the at least one bypass line opens outside the suction strainer in such a way that fluid flowing out through the at least one bypass line flows approximately or substantially orthogonally to the at least one lateral suction opening, in particular with respect to its normal. In other words, the at least one bypass line opening outside the suction strainer preferably has an outlet opening arranged in such an oriented manner that it extends approximately or substantially orthogonally to the at least one lateral suction opening. The at least one bypass line opening out in the suction strainer for purging the suction strainer preferably has an outlet opening oriented in such a way that the outflowing fluid flows out radially in the direction of the axis. The outlet opening is preferably funnel-shaped.

According to another preferred development, the at least one bypass line has at least one first and one second bypass line, each of which may be connected to the at least one pressure outlet, the at least one first bypass line opens out outside the suction strainer for purging the centrifugal pump, in particular, the at least one pressure outlet is connected to the at least one first bypass line only in the third position, the at least one second bypass line opens out into the suction strainer for purging the suction strainer and, in particular, the at least one pressure outlet is connected to the at least one second bypass line only in a fourth position. The at least one first bypass line and the at least one second bypass line preferably each have an inlet opening, which are recessed into an inner wall of the suction strainer at a circumferential distance from one another. Preferably, the inlet openings are provided axially spaced above the at least one lateral suction opening. Particularly preferably, four bypass lines or four first bypass lines and four second bypass lines are provided, wherein the inlet openings of the bypass lines are preferably arranged in particular centrally between two groups of lateral suction openings.

According to a further preferred embodiment, the suction strainer may be removed axially from the centrifugal chamber in a fifth position. By removing the suction strainer, the suction strainer may be easily maintained and/or cleaned.

According to another preferred development, the centrifugal chamber and the suction strainer are configured to be axially displaceable between the first position and the second position and rotatable relative to one another between the first position and the third position. Preferably, in the second position, in particular only in the second position, the centrifugal chamber lies in contact with the suction strainer, in particular on the suction strainer base, so that the centrifugal chamber side wall closes the at least one lateral suction opening. In all other positions, in particular in the first position, the third position, the fourth position and/or the fifth position, the centrifugal chamber base is preferably arranged at an angle to the suction strainer base, so that the at least one lateral suction opening is not deactivated by the centrifugal chamber.

According to a further preferred embodiment, the suction strainer has at least one guide track and the centrifugal chamber has at least one guide lug engaging in the at least one guide track for rotating and/or displacing the centrifugal chamber and the suction strainer relative to each other. Preferably, four guide lugs are provided, which extend radially away from the centrifugal chamber side wall. Accordingly, four guide tracks are also preferably provided, which are arranged at regular intervals and/or in a manner corresponding to the guide lugs. The at least one guide track preferably extends radially into an inner wall of the centrifugal chamber. The at least one guide track is preferably formed like a groove and/or allows a form-fit connection of the suction strainer to the centrifugal chamber.

The at least one guide track preferably initially extends axially to connect the centrifugal chamber to the suction strainer or the suction strainer to the centrifugal chamber in the fifth position, and then bends orthogonally in an L-shaped manner, extending further at the same axial height, in particular when viewed from above with respect to the inner wall of the centrifugal chamber. Preferably, the fifth position, the first position, the third position and/or the fourth position are at the same axial height. From this same axial height, the at least one guide track preferably bends axially again orthogonally, extending further axially in the direction of the suction strainer base, in order to form the second position. This bend may be T-shaped in plan view, which in turn is followed by an L-shaped bend in plan view, in the extension of which the second position may be formed at the same axial height.

According to another preferred development, the at least one pressure outlet opens out into the at least one guide lug and guides the at least one bypass line away from the at least one guide track. Preferably, the guide nose has a cuboid shape in a radial plan view of the centrifugal chamber, into which the at least one pressure outlet, which in particular has a circular diameter, is inserted. The in particular circular inlet opening of the bypass line, from which the bypass line leads away, is preferably inserted into an axially extending base of the guide track.

According to a further preferred embodiment, the centrifugal chamber and the suction strainer are configured to be lockable relative to one another in at least the first, second and third and, in particular, the fourth position. For the previously mentioned locking and/or latching, a latching lug or the like may be provided, which is arranged, for example, projecting radially outwards on the guide lug and may latch into a corresponding recess in the guide track provided at the respective position.

According to another preferred development, a centrifugal chamber base of the suction strainer located on the outside of the centrifugal chamber has at least one feed channel extending radially towards the at least one suction opening on the base side. Fluid may flow through the feed channel, which is configured in particular like a piece of cake, towards the at least one suction opening on the base side. For this purpose, the feed channel is configured to be open towards the floor in particular and is delimited or formed on one side by the suction strainer and on the other side by feet provided on the suction strainer. The feet may have a rectangular, radially extending shape. The axial height of the feet is advantageously smaller than the axial height of the at least one lateral suction opening.

According to a further preferred embodiment, the suction strainer has a plurality of base-side suction openings and a plurality of lateral suction openings arranged in particular at regular intervals and/or at the same axial height, the at least one base-side suction opening has a smaller cross-sectional area than the at least one lateral suction opening, the at least one base-side suction opening has a circular cross-section and/or the at least one lateral suction opening has a rectangular, in particular square, cross-section and/or a plurality of spaced groups of at least one lateral suction opening are provided.

According to another preferred development, the centrifugal chamber has a pot-like outer shape with a particularly circular outer diameter and/or the suction strainer has a pot-like inner shape with a particularly circular inner diameter. The centrifugal chamber and/or the suction strainer are preferably pot-like.

According to a further preferred embodiment, the suction strainer has a polygonal cross-section and the at least one bypass line for purging the centrifugal pump opens out at a corner of the polygonal cross-section. Such a polygonal cross-section, configured for example as an equilateral rectangle, may achieve efficient purging of the at least one lateral suction opening, since the fluid flow may flush past or does flush past all lateral suction openings in particular and may thus free the lateral suction openings from contamination or the like.

According to another preferred development, the centrifugal chamber has at least one main pressure outlet for receiving a large part of the fluid conveyed by the impeller and the at least one pressure outlet is arranged in the region of the at least one main pressure outlet. The at least one main pressure outlet is fluidically connected in particular to a cooling jacket of the centrifugal pump. Preferably, the pressure outlet is arranged directly upstream of the main pressure outlet when viewed in the direction of circulation. The pressure outlet is also preferably configured as a tubular, radially extending channel.

### BRIEF DESCRIPTION OF THE DRAWINGS

In the following, the invention is explained in more detail with reference to the accompanying drawings with reference to preferred exemplary embodiments.

### In the Drawings

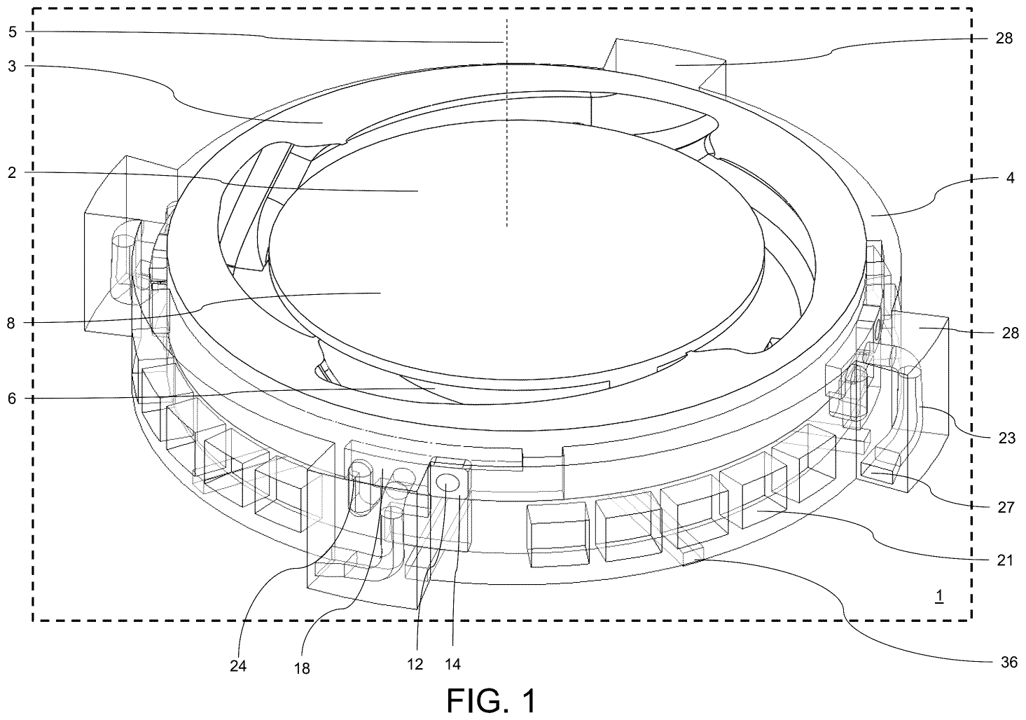

FIG. 1 shows a schematic perspective partial sectional view of a part of a centrifugal pump with a centrifugal chamber, in which a partially shown impeller is axially inserted, and a suction strainer, in which the centrifugal chamber is axially inserted, according to a preferred exemplary embodiment of the invention,

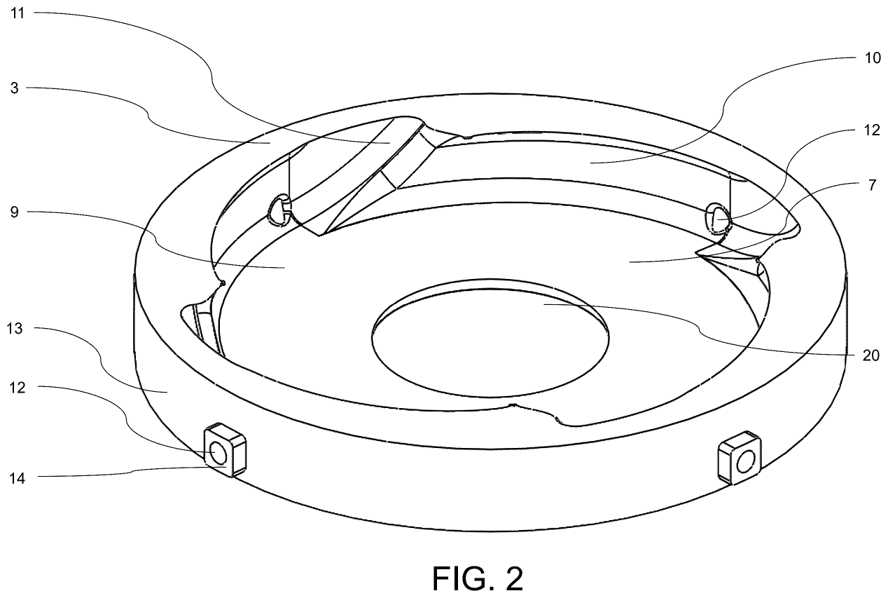

FIG. 2 shows a perspective view of the centrifugal chamber of FIG. 1 according to the preferred exemplary embodiment of the invention,

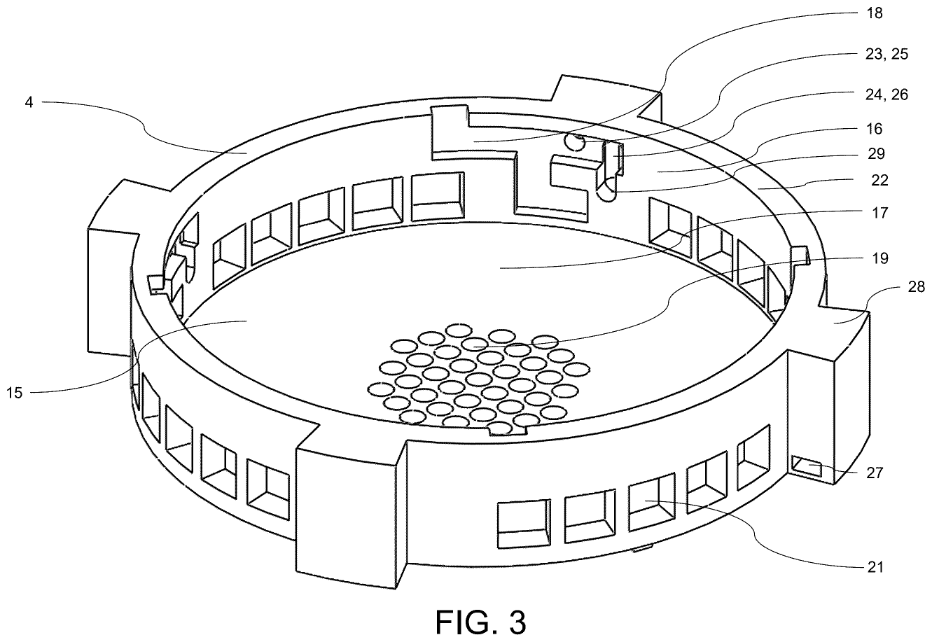

FIG. 3 shows a perspective view of the suction strainer of FIG. 1 according to the preferred exemplary embodiment of the invention,

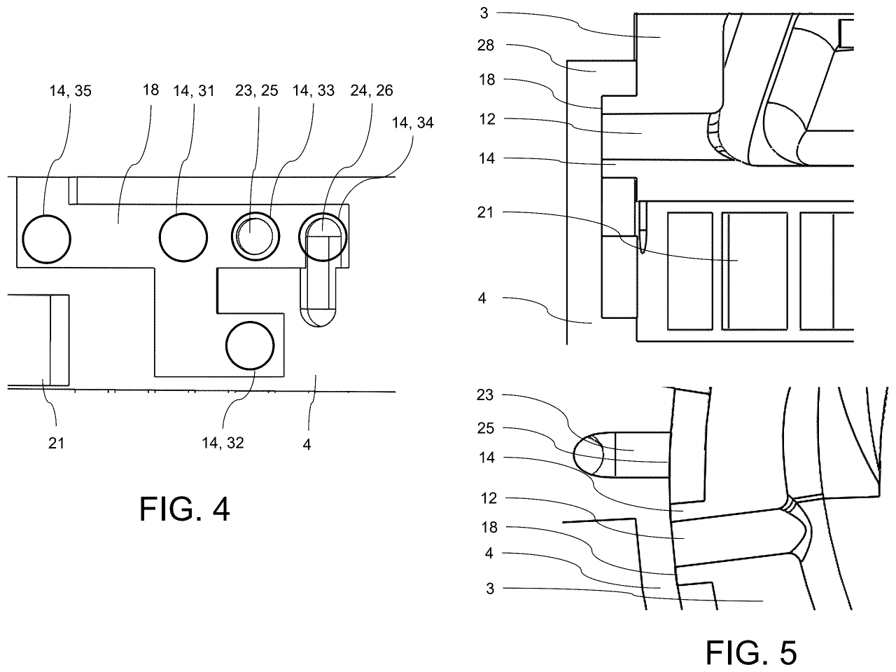

FIG. 4 shows a plan view of a guide track of the suction strainer of FIG. 1 according to the preferred exemplary embodiment of the invention,

FIG. 5 shows above in axial sectional view and below in axial plan view a first position of a guide lug on the guide track of FIG. 4 according to the preferred exemplary embodiment of the invention,

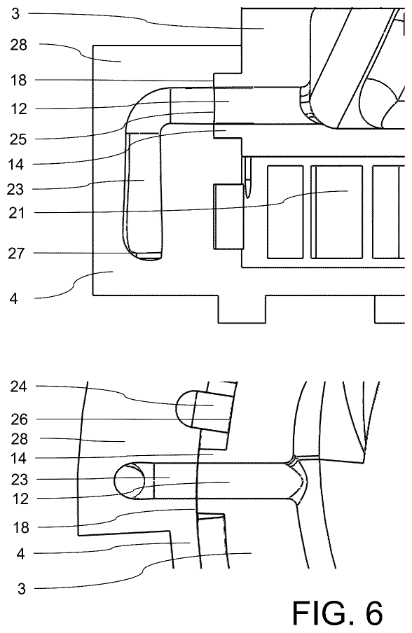

FIG. 6 shows above in axial sectional view and below in axial plan view a third position of the guide lug on the guide track of FIG. 4 according to the preferred exemplary embodiment of the invention,

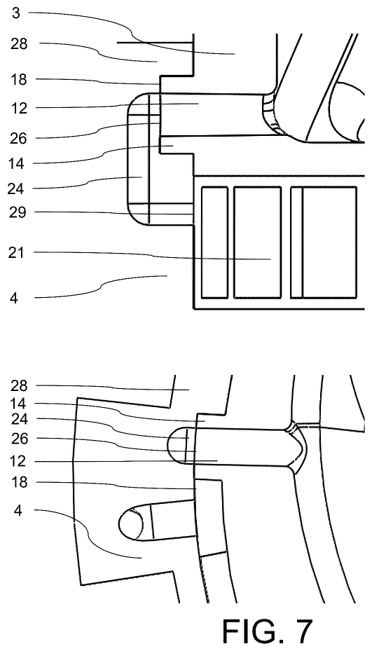

FIG. 7 shows above in axial sectional view and below in axial plan view a fourth position of the guide lug on the guide track of FIG. 4 according to the preferred exemplary embodiment of the invention,

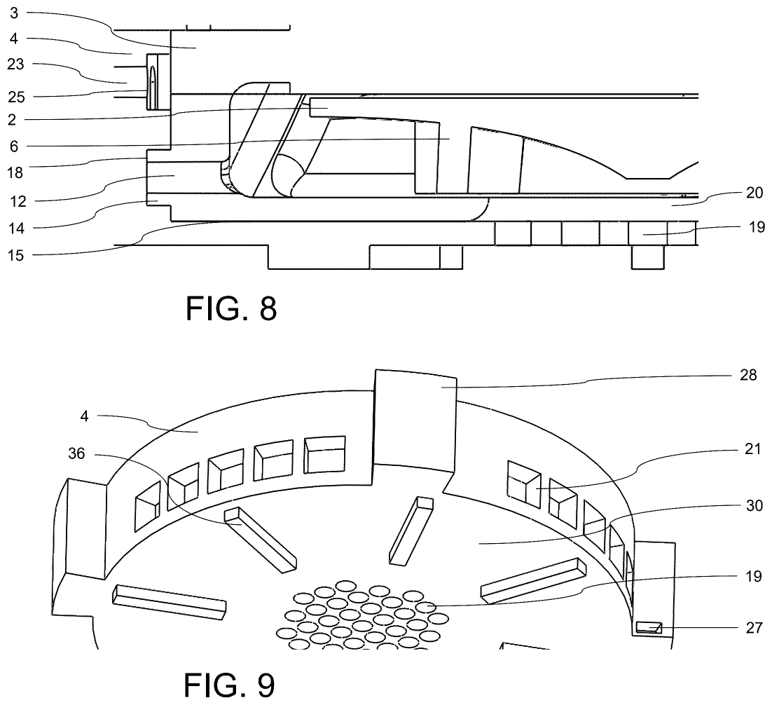

FIG. 8 shows an axial sectional view of a second position of the guide lug on the guide track of FIG. 4 according to the preferred exemplary embodiment of the invention, and

FIG. 9 shows a perspective partial bottom view of the suction strainer of FIG. 1 according to the preferred exemplary embodiment of the invention.

### DETAILED DESCRIPTION OF THE EXEMPLARY EMBODIMENTS

FIG. 1 shows a schematic perspective partial sectional view of a part of a centrifugal pump 1, shown only purely schematically, according to a preferred exemplary embodiment of the invention. The centrifugal pump 1 has an impeller 2, only partially shown in FIG. 1, for conveying a fluid, a centrifugal chamber 3 and a suction strainer 4. The impeller 2 defines an axis 5 along which a shaft, not shown in FIG. 1, extends axially. The shaft is driven by a motor not shown, so that blades 6 of the impeller 2 may convey the fluid.

As is visible in detail in FIG. 2, the centrifugal chamber 3 has a pot-like shape with a circular outer diameter and circular centrifugal chamber recess 7, in which the impeller 2 is inserted axially, as shown in FIG. 1. For this purpose, the impeller 2 has a disc-like plate 8 extending around the axis 5 at its end facing the centrifugal chamber 3, as is visible in FIG. 1. The shaft, which is not shown, extends along the axis 5 away from the plate 8 and the centrifugal chamber 3. The blades 6, which are formed integrally with the plate 8, extend axially in the direction of the centrifugal chamber 3 away from the plate 8. The plate 8 extends radially and the blades 6 extend both axially and radially right up to the centrifugal chamber 3. The centrifugal chamber recess 7 thus corresponds to an outer shape of the impeller 2.

As may also be seen in FIG. 2, the centrifugal chamber recess 7 has a radially extending centrifugal chamber base 9 with an inner centrifugal chamber wall 10 extending axially away from it in the direction of the shaft, which axially and radially delimit the impeller 2 inserted in the centrifugal chamber 3 in FIG. 1. Four lance-like main pressure outlets 11 for connection to a cooling jacket of the centrifugal pump (not shown) are set into the inner wall 10 of the centrifugal chamber at regular intervals. One end of the lance-like main pressure outlets 11 is recessed axially into the centrifugal chamber base 9 and their opposite other end extends axially away from the centrifugal chamber base 9 in the direction of the shaft. The inner wall 10 of the centrifugal chamber tapers continuously as far as the respective main pressure outlet 11, in order to project again radially in the direction of the shaft 5 after the respective main pressure outlet 11 or the respective ramp.

A tubular, radially extending pressure outlet 12 is provided axially at the level of the bottom 9 of the centrifugal chamber, extending in front of the ramp-like main pressure outlet 11 and directly in front of the end of the main pressure outlet 11 which is axially recessed into the bottom 9 of the centrifugal chamber. The respective pressure outlet 12 extends through the centrifugal chamber inner wall 10 to an axially extending centrifugal chamber outer wall 13 of the centrifugal chamber 3 and opens out at the centrifugal chamber outer wall 13 into a guide lug 14 moulded onto the centrifugal chamber outer wall 13. The moulded-on guide lug 14 has a cuboid shape with the pressure outlet 12 opening into the centre of the lug in a radial plan view of the centrifugal chamber 3 and extends radially away from the outer wall 13 of the centrifugal chamber. The four guide lugs 14 are provided at 90° to each other on the outer wall 13 of the centrifugal chamber 3. The pressure outlet 12 leading in this way from the impeller 2 to the suction strainer 4 takes up part of the fluid conveyed by the impeller 2 when conveying fluid.

As may also be seen in FIG. 1, the centrifugal chamber 3 is inserted axially in the suction strainer 4 shown in detail in FIG. 3. Like the centrifugal chamber 3, the suction strainer 4 has a pot-like shape that corresponds to the centrifugal chamber 3, but is axially longer than the centrifugal chamber 3 so that the centrifugal chamber 3 may be fully inserted into the suction strainer 4. The suction strainer 4 has a radially extending suction strainer base 15 and an axially extending suction strainer inner wall 16 attached to it, which form a disc-like suction strainer recess 17 for inserting the centrifugal chamber 3 into it.

Four regularly spaced guide tracks 18 are provided in the suction strainer inner wall 16 and are configured as rectangular grooves extending radially into the suction strainer inner wall 16 and corresponding in cross-section to the guide lugs 14. FIG. 4 shows a plan view of the suction strainer inner wall 16 of one of the guide tracks 18. By means of the guide lugs 14 engaging form-fittingly in the guide tracks 18 with respect to the cross-section, the centrifugal chamber 3 and the suction strainer 4 may be rotated and/or displaced relative to each other into five different positions, indicated in FIG. 4 by circles of the guide lugs 14.

Returning to FIG. 3, a plurality of adjacent base-side suction openings 19 with a circular cross-section are provided in the suction strainer base 15 distributed around the axis 5 for sucking in the fluid and extend in the axial direction through the suction strainer base 16. Corresponding to the plurality of adjacent base-side suction openings 19, an opening 20 is provided in the centrifugal chamber base 9. Each suction opening 19 on the base side has the same cross-section.

Four groups of five lateral suction openings 21, each with a square cross-section, are provided in the inner wall of the suction strainer 16 to draw in the fluid. Each lateral suction opening 21 has the same cross-section, wherein the base-side suction opening 19 has a smaller cross-sectional area than the lateral suction opening 21. The five lateral suction openings 21 are arranged at regular intervals and at the same axial height, oriented towards the suction strainer base 15 and spaced apart from an upper suction strainer rim 22 facing the shaft, and extend radially through the inner wall 16 of the suction strainer. Specifically, the lateral suction openings 21 are arranged axially approximately at the level of the suction strainer base 15. A guide track 18 is provided substantially between each of two groups of five lateral suction openings 21.

The suction strainer 4 also has four groups of two first and second bypass lines 23, 24, which may be connected to the respective pressure outlet 12 and by means of which the centrifugal pump 1 and the suction strainer 4 may be purged. Both the first and the second bypass lines 23, 24 start at the guide track 18, with the first bypass line 23 opening outside the suction strainer 4 for purging the centrifugal pump 1 and the second bypass line 24 opening in the suction strainer 4 for purging the suction strainer 4. Both the first and the second bypass line 23, 24 have a respective inlet opening 25, 26, which is arranged in the base of the groove-like guide track 18. The two inlet openings 25, 26 are provided at the same axial height but at a distance from each other and axially above the lateral suction openings 21 in relation to the suction strainer base 15.

An outlet opening 27 of the first bypass line 23 is arranged axially at an angle to the corresponding inlet opening 25 of the first bypass line 23 at the level of the suction strainer base 15 and thus axially below the lateral suction openings 21. The suction strainer 4 has a cuboidal projection 28 in radial plan view, which extends radially away from the suction strainer 4 and axially between the suction strainer base 15 and the suction strainer rim 22, within which the first bypass line 23 is arranged and extends axially between inlet opening 25 and outlet opening 27. As is visible from FIG. 3, the outlet opening 27 of the first bypass line 23 is assigned to the group of the five lateral suction openings 21 and is arranged in a circumferential extension next to the group in such a way that the outlet opening 27 of the first bypass line 23 is oriented substantially orthogonally to the outermost lateral suction opening 21. The inlet opening 25 of the first bypass line 23 has a circular cross-section and the outlet opening 27 of the first bypass line 23 has a rectangular cross-section, the longitudinal side of which is oriented parallel to the suction strainer base 15.

The second bypass line 24 has a C-shaped course in axial side view, wherein the inlet opening 26 of the second bypass line 24 is arranged axially above an outlet opening 29 of the second bypass line 24 in relation to the suction strainer base 17. The second bypass line 24 extends along its C-shaped path into the projection 28, wherein the inlet opening 26 of the second bypass line 24 and the outlet opening 29 of the second bypass line 24 are configured as a common opening in the form of an axially extending slot. Accordingly, the outlet opening 29 of the second bypass line 24 opens out axially below the guide track 18 in relation to the suction strainer base 17.

As described above, four regularly spaced guide tracks 18 are provided in the inner wall 16 of the suction strainer and are configured as grooves extending radially into the inner wall 16 of the suction strainer and corresponding in cross-section to the guide lugs 14. By means of the guide lugs 14 engaging in the guide tracks 18, the centrifugal chamber 3 and the suction strainer 4 may be rotated and/or displaced relative to each other into five different positions, indicated in FIG. 4 by circles as five different positions 31, 32, 33, 34, 25 of the guide lugs 14 in the guide track 18.

Starting on the left in FIG. 4, the guide track 18 first runs axially in the direction of the suction strainer base 15 and then extends orthogonally to it at the same axial height. The fifth position 35, in which the suction strainer 4 may be axially removed from or axially placed on the centrifugal chamber 3, is located at this intersection between the axial extension and the extension at the same axial height. The first position 31, the third position 33 and the fourth position 34 are located at this same axial height next to the fifth position 35 and are each spaced apart from one another in the following order, while the second position 32 is arranged axially spaced apart in the direction of the suction strainer base 15 below the third position 33. Accordingly, the guide track 18 extends or is limited at the same axial height by the fifth position 35 on the one hand and by the fourth position 34 on the other. In the area of the first position 31, the guide track 18 branches out in a T-shape, initially running axially in the direction of the suction strainer base 15 and then orthogonally thereto at the same axial height up to the second position 32.

In the first position 31, which is assumed during normal operation of the centrifugal pump 1, both the lateral and the base-side suction openings 19, 21 are open, while the pressure outlet 12 is closed. FIG. 5 shows the first position 31, namely a part of the guide track 18 with the guide lug 14 at the top in axial sectional view and at the bottom in axial plan view. As is visible from the upper FIG. the pressure outlet 12 is in contact with the base of the guide track 18 and is thus closed by the base of the guide track 18. In this respect, no fluid may enter the first and second bypass lines 23, 24 from the pressure outlet 12. The centrifugal chamber 3 is arranged axially above the lateral suction openings 21 in relation to the suction strainer base 15, so that the lateral suction openings 21 are open. Fluid may be drawn in and conveyed through the impeller 2 through the radial and base-side suction openings 19, 21 opened in this way-FIG. 5 only shows the lateral suction openings 21.

FIG. 6 shows the third position 33 of a so-called “twister operation”, again shown as a part of the guide track 18 with the guide lug 14 at the top in axial sectional view and at the bottom in axial plan view. Compared to the first position 31, the centrifugal chamber 3 and the suction strainer 4 are rotated axially relative to each other at the same axial height. Accordingly, both the side and bottom suction openings 19, 21 are still open. As a result of the twisting, the pressure outlet 12 is no longer closed by the base of the guide track 18, but instead opens at the inlet opening 25 of the first bypass line 23, which is thus connected to the pressure outlet 12 in a fluid-tight manner. Accordingly, a portion of the fluid conveyed by the impeller 2 flows through the pressure outlet 12 into the first bypass line 23 and flows out at the outlet opening 27 of the first bypass line 23 in order to cause the centrifugal pump 1 to be purged.

FIG. 7 shows the fourth position 34 for backflushing the suction strainer 4, again shown as a part of the guide track 18 with the guide lug 14 at the top in axial sectional view and at the bottom in axial plan view. Compared to the third position 33, the centrifugal chamber 3 and the suction strainer 4 are rotated axially even further towards each other at the same axial height than towards the first position 31. Accordingly, both the side and bottom suction openings 19, 21 are still open. Due to the even further rotation, the pressure outlet 12 is also no longer closed by the base of the guide track 18 and is no longer connected to the inlet opening 25 of the first bypass line 23, but now only to the inlet opening 26 of the second bypass line 24, which is thus connected to the pressure outlet 12 in a fluid-tight manner. Accordingly, the part of the fluid conveyed by the impeller 2 flows through the pressure outlet 12 into the second bypass line 24 and flows out at the outlet opening 29 of the second bypass line 23 into the suction strainer 4 in order to cause the suction strainer 4 to be purged.

FIG. 8 shows the second position 32 in axial sectional view for so-called flat suction. In the second position 32, as described above, the centrifugal chamber 3 is inserted axially lower in the suction strainer 4 in relation to the suction strainer base 15 and the suction strainer 4 is attached axially higher to the centrifugal chamber 3 than in all other positions.

Specifically, the centrifugal chamber 3 is in axial contact with the suction strainer base 15 or the suction strainer 4. The pressure outlet 12 is in contact with the base of the guide track 18 and is thus closed by the base of the guide track 18.

While the centrifugal chamber 3 is arranged axially above the lateral suction openings 21 in all other positions described above in relation to the suction strainer base 15, in the second position 32 the outer wall 13 of the centrifugal chamber 3 is in contact with the lateral suction openings 21 and thus closes them. The base-side suction openings 19, through which fluid is conveyed by means of the impeller 2, are still open or only open. For this purpose, as may be seen in FIG. 9, several pie-shaped feed channels 30 extending radially towards the suction openings 19 on the base of the suction strainer 4 are formed on the suction strainer base 15. The feed channels 30 are radially limited by radially extending, cuboid feet 36 provided on the suction strainer base 15.

Finally, the centrifugal chamber 3 and the suction strainer 4 or the guide lug 14 and the guide track 18 are configured to be lockable relative to one another in the first, second, third and fourth positions 31, 32, 33, 34, so that the corresponding position 31, 32, 33, 34 is maintained while the fluid is being conveyed. In addition, the centrifugal chamber 3 and the suction strainer 5 are sealed radially against each other, in particular by means of a sealing lip.

The described exemplary embodiments are simply examples, which may be modified and/or added to in a variety of ways within the scope of the claims. Each feature, which has been described for a particular exemplary embodiment, may be used independently or in combination with other features in any other exemplary embodiment. Each feature, which has been described for an exemplary embodiment of a certain category, may also be inserted in a corresponding manner in an exemplary embodiment of another category.

List of reference signs

| | |
|---|---|
| centrifugal pump | 1 |
| impeller | 2 |
| centrifugal chamber | 3 |
| suction strainer | 4 |
| axis | 5 |
| blade | 6 |
| centrifugal chamber recess | 7 |
| plate | 8 |
| centrifugal chamber base | 9 |
| centrifugal chamber inner wall | 10 |
| main pressure outlet | 11 |
| pressure outlet | 12 |
| centrifugal chamber outer wall | 13 |
| guide lug | 14 |
| suction strainer base | 15 |
| suction strainer inner wall | 16 |
| suction strainer recess | 17 |
| guide track | 18 |
| base-side suction opening | 19 |
| opening | 20 |
| lateral suction opening | 21 |
| suction strainer rim | 22 |
| first bypass line | 23 |
| second bypass line | 24 |
| inlet opening of the first bypass line | 25 |
| inlet opening of the second bypass line | 26 |
| outlet opening of the first bypass line | 27 |
| projection | 28 |
| outlet opening of the second bypass line | 29 |
| feed channel | 30 |
| first position | 31 |
| second position | 32 |
| third position | 33 |
| fourth position | 34 |
| fifth position | 35 |
| foot | 36 |

1. A centrifugal pump with an impeller defining an axis for conveying a fluid, a centrifugal chamber in which the impeller is axially inserted, and a suction strainer in which the centrifugal chamber is axially inserted, wherein
the centrifugal chamber has at least one pressure outlet leading from the impeller to the suction strainer for receiving a portion of the fluid conveyed by the impeller,
the suction strainer has at least one base-side and at least one lateral suction opening for sucking in the fluid and at least one bypass line, which is connectable to the at least one pressure outlet, for purging the centrifugal pump and/or the suction strainer, and
the centrifugal chamber and the suction strainer are rotatable and/or axially displaceable relative to one another in at least a first, a second and a third position, in such a way that at least in the first position the at least one lateral suction opening is open, in the second position the at least one lateral suction opening is deactivated and in the third position the at least one pressure outlet is connected to the at least one bypass line.

2. The centrifugal pump according to claim 1, wherein at least one of in the first position and in the second position at least one of the at least one pressure outlet and the at least one bypass line is deactivated, in the second position only the base-side suction opening is open, in the third position the at least one lateral suction opening is open and only in the third position the at least one pressure outlet is connected to the at least one bypass line.

3. The centrifugal pump according to claim 1, wherein the at least one bypass line opens out at least one of outside the suction strainer for purging the centrifugal pump and in the suction strainer for purging the suction strainer.

4. The centrifugal pump according to claim 1, wherein the at least one bypass line has at least a first and a second bypass line which are each connectable to the at least one pressure outlet, the at least one first bypass line opens out outside the suction strainer for purging the centrifugal pump, and the at least one second bypass line opens out into the suction strainer for purging the suction strainer.

5. The centrifugal pump according to claim 1, wherein the at least one bypass line has at least a first and a second bypass line which are each connectable to the at least one pressure outlet, and at least one of only in the third position the at least one pressure outlet is connected to the at least one first bypass line and only in a fourth position the at least one pressure outlet is connected to the at least one second bypass line.

6. The centrifugal pump according to claim 1, wherein the suction strainer is axially removable from the centrifugal chamber in a fifth position.

7. The centrifugal pump according to claim 1, wherein the centrifugal chamber and the suction strainer are axially displaceable between the first position and the second position and are rotatable relative to one another between the first position and the third position.

8. The centrifugal pump according to claim 1, wherein the suction strainer has at least one guide track and the centrifugal chamber has at least one guide lug engaging in the at least one guide track for at least one of rotating and displacing the centrifugal chamber and the suction strainer relative to one another.

9. The centrifugal pump according to claim 8, wherein the at least one pressure outlet opens out in the at least one guide lug and the at least one bypass line leads away from the at least one guide track.

10. The centrifugal pump according to claim 1, wherein the centrifugal chamber and the suction strainer are configured to be lockable relative to one another in the at least first, second and third position.

11. The centrifugal pump according to claim 1, wherein the centrifugal chamber and the suction strainer are configured to be lockable relative to one another in the at least first, second, third and fourth position.

12. The centrifugal pump according to claim 1, wherein a suction strainer base located externally with respect to the centrifugal chamber has at least one feed channel extending radially towards the at least one base-side suction opening.

13. The centrifugal pump according to claim 1, wherein at least one of the suction strainer has a plurality of base-side suction openings and a plurality of radial suction openings arranged in at least one of regular intervals and at the same axial height, the at least one base-side suction opening has a smaller cross-sectional area than the at least one lateral suction opening, the at least one base-side suction opening has a circular cross-section and/or the at least one lateral suction opening has a rectangular cross-section and a plurality of spaced-apart groups of the at least one lateral suction openings are provided.

14. The centrifugal pump according to claim 1, wherein at least one the centrifugal chamber has a pot-like outer shape with a circular outer diameter and the suction strainer has a pot-like inner shape with a circular inner diameter.

15. The centrifugal pump according to claim 1, wherein at least one the centrifugal chamber has a pot-like outer shape and the suction strainer has a pot-like inner.

16. The centrifugal pump according to claim 1, wherein the suction strainer has a polygonal cross-section and the at least one bypass line for purging the centrifugal pump opens out at a corner of the polygonal cross-section.

17. The centrifugal pump according to claim 1, wherein the centrifugal chamber has at least one main pressure outlet for receiving a large part of the fluid conveyed by the impeller and the at least one pressure outlet is arranged in the region of the at least one main pressure outlet.
